(19) United States
(12) Patent Application Publication
(10) Pub. No.: US 2025/0030105 A1
(43) Pub. Date: Jan. 23, 2025

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 18/636,668

(22) Filed: Apr. 16, 2024

(30) Foreign Application Priority Data
Jul. 20, 2023 (JP) JP2023-118530

(51) Int. Cl. H01M 50/256; H01M 10/613; H01M 10/643; H01M 10/6555; H01M 50/213

(52) U.S. Cl. CPC H01M 50/256; H01M 10/613; H01M 10/643; H01M 10/6555; H01M 50/213

(57) ABSTRACT

A battery pack is provided including a plurality of cylindrical batteries; a heat absorbing member disposed between one cylindrical battery and another cylindrical battery of the plurality of cylindrical batteries; and a battery holder that houses the plurality of cylindrical batteries and the heat absorbing member, in which the battery holder includes an enclosure along an outer periphery of the plurality of cylindrical batteries, a first groove extending along an axial direction of the cylindrical battery housed in the battery holder and a second groove extending along a circumferential direction of the cylindrical battery housed in the battery holder are provided on an inner surface of the enclosure of the battery holder, and the first groove and the second groove are connected to each other.

### CROSS REFERENCE TO RELATED APPLICATIONS

The present application claims priority to Japanese patent application no. 2023-118530, filed on Jul. 20, 2023, the entire contents of which are incorporated herein by reference.

### BACKGROUND

The present disclosure relates to a battery pack.

A battery pack is provided including a plurality of cylindrical batteries and a battery holder, an air layer is formed between a longitudinal groove provided on an inner surface of an insertion portion of the battery holder into which the cylindrical battery is inserted and extending in a longitudinal direction of the cylindrical battery and an outer peripheral surface of the cylindrical battery. A battery module is provided including a battery unit including two or more unit cells, a housing that houses the battery unit, and a heat absorbing member provided in contact with a side surface of the battery. In an aspect in which the heat absorbing member is provided in contact with a side surface of each unit cell between the unit cells of the battery unit, a recess is provided in the housing to determine an arrangement position of the heat absorbing member.

### SUMMARY

The present disclosure relates to a battery pack.

In the conventional battery pack, the air layer is provided between the longitudinal groove extending in the longitudinal direction of the cylindrical battery and the outer peripheral surface of the cylindrical battery to block heat transfer from the overheated cylindrical battery by the air layer, and thus to suppress heat conduction between adjacent cylindrical batteries.

However, since a position where the air layer is formed depends on the form of the longitudinal groove extending in the longitudinal direction of the cylindrical battery, it may be difficult to suppress heat conduction of the cylindrical battery over a wide range depending on a heat transfer direction of the overheated cylindrical battery and the like.

In the aspect in which the heat absorbing member is provided in contact with the side surface of each unit cell between the unit cells of the battery unit in the conventional battery module, depending on the structure of the recess of the housing in which the heat absorbing member can be disposed, abnormal heat generation of the unit cell in which a failure occurs may not be suitably absorbed by a heat absorbing agent.

The present disclosure relates to providing a battery pack capable of suitably suppressing heat conduction over a wide range of a cylindrical battery according to an embodiment.

In an embodiment, the present disclosure provides a battery pack including: a plurality of cylindrical batteries; a heat absorbing member disposed between one cylindrical battery and another cylindrical battery of the plurality of cylindrical batteries; and a battery holder that houses the plurality of cylindrical batteries and the heat absorbing member, in which the battery holder includes an enclosure along an outer periphery of the plurality of cylindrical batteries, a first groove extending along an axial direction of the cylindrical battery housed in the battery holder and a second groove extending along a circumferential direction of the cylindrical battery housed in the battery holder are provided on an inner surface of the enclosure of the battery holder, and the first groove and the second groove are connected to each other.

In an embodiment, the present disclosure provides a battery pack including: a plurality of cylindrical batteries; a heat absorbing member disposed between one cylindrical battery and another cylindrical battery of the plurality of cylindrical batteries; and a battery holder that houses the plurality of cylindrical batteries and the heat absorbing member, in which the battery holder includes an enclosure along an outer periphery of the plurality of cylindrical batteries, a plurality of protrusions are provided on an inner surface of the enclosure, and the plurality of protrusions are provided along a circumferential direction of the cylindrical battery housed in the battery holder, and are provided along an axial direction of the cylindrical battery housed in the battery holder.

Furthermore, in an embodiment, the present disclosure provides a battery pack including: a plurality of cylindrical batteries; a heat absorbing member disposed between one cylindrical battery and another cylindrical battery of the plurality of cylindrical batteries; and a battery holder that houses the plurality of cylindrical batteries and the heat absorbing member, in which the battery holder includes an enclosure along an outer periphery of the plurality of cylindrical batteries, a plurality of protrusions are provided on an inner surface of the enclosure of the battery holder, a first groove extending along an axial direction of the cylindrical battery housed in the battery holder and a second groove extending along a circumferential direction of the cylindrical battery housed in the battery holder are provided on the inner surface of the enclosure of the battery holder, and the protrusion includes a portion surrounded by the first groove and the second groove.

According to the battery pack of the present disclosure, it is possible to suitably suppress heat transfer of a cylindrical battery over a wide range.

### BRIEF DESCRIPTION OF THE FIGURES

FIG. 1 is an exploded perspective view schematically showing a battery pack of an embodiment of the present disclosure;

FIG. 2 is an exploded perspective view schematically showing a core pack in the battery pack of an embodiment;

FIG. 3 is a sectional view schematically showing a positional relationship between a battery holder and a heat absorbing member in the battery pack of an embodiment;

FIG. 4 is a sectional view schematically showing the battery holder between line segments A-A in FIG. 1;

FIG. 5 is a sectional view schematically showing a first battery holder component in the battery pack of an embodiment;

FIG. 6 is a front view schematically showing the first battery holder component viewed from an angle different from that in FIG. 5;

FIG. 7 is a sectional view schematically showing a second battery holder component in the battery pack of an embodiment;

FIG. 8 is a front view schematically showing the second battery holder component viewed from an angle different from that in FIG. 7;

FIG. 9 is a schematic view of a formation mode of a first groove and a second groove of the battery holder using a plurality of the battery holder components in the battery pack of an embodiment;

FIG. 10 is a sectional view schematically showing a battery holder between line segments A-A in FIG. 1 in a battery pack of an embodiment of the present disclosure;

FIG. 11 is a schematic view of a formation mode of a first groove and a second groove of the battery holder using a plurality of battery holder components in the battery pack of an embodiment;

FIG. 12 is a schematic view of a formation mode of a first groove and a second groove of a battery holder using a plurality of battery holder components in a battery pack of an embodiment;

FIG. 13 is a schematic view of a formation mode of a first groove and a second groove of a battery holder using a plurality of battery holder components in a battery pack of an embodiment;

FIG. 14 is a schematic view of a formation mode of a first groove and a second groove of a battery holder using a plurality of battery holder components in a battery pack of an embodiment; and

FIG. 15 is a schematic view of a formation mode of a first groove and a second groove of a battery holder using a plurality of battery holder components in a battery pack of an embodiment.

### DETAILED DESCRIPTION

The present disclosure is described below in further detail including with reference to the drawings according to an embodiment. Although the description will be made with reference to the drawings as necessary, various elements in the drawings are merely schematically and exemplarily shown for understanding of the present disclosure, and the appearance and the dimensional ratio and the like can be different from those of actual ones.

The various numerical ranges referred to herein are intended to include the lower limit and upper limit numerical values themselves, unless otherwise noted, such as “less than” or “greater than/greater than”. That is, when a numerical range such as 1 to 10 is taken as an example, it can be interpreted as including the lower limit of “1” and also including the upper limit of “10”. The terms “about” and “degree” mean that they may include variations of a few percent, e.g., ±10%.

The term “in planar view” in the present specification refers to a state when an object (e.g., a battery pack) is placed and viewed from directly above the thickness (height) direction. The term “in side view” in the present specification refers to a state when an object (e.g., a battery pack) is placed and viewed from a side perpendicular to the thickness (height) direction unless otherwise specified. The term “in front view” in the present specification refers to a state when an object (e.g., a battery pack) is placed and viewed from an axial direction of a cylindrical cell unless otherwise specified.

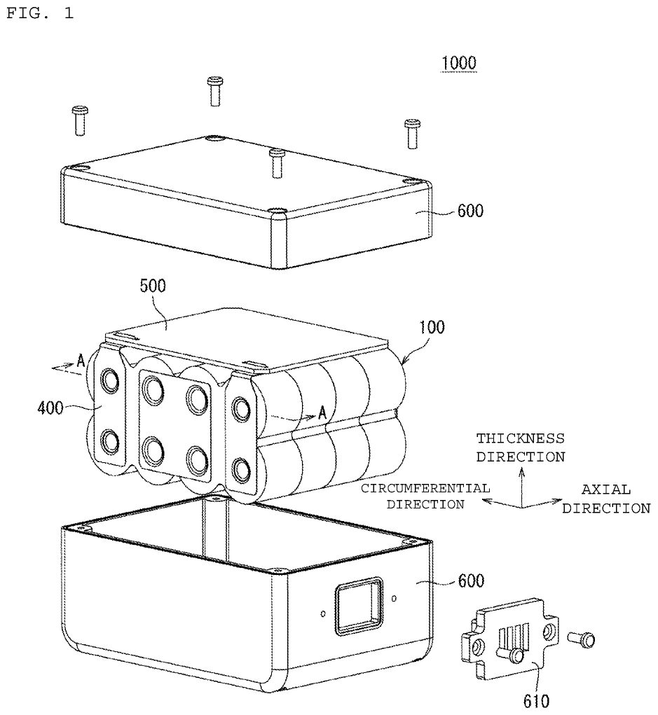

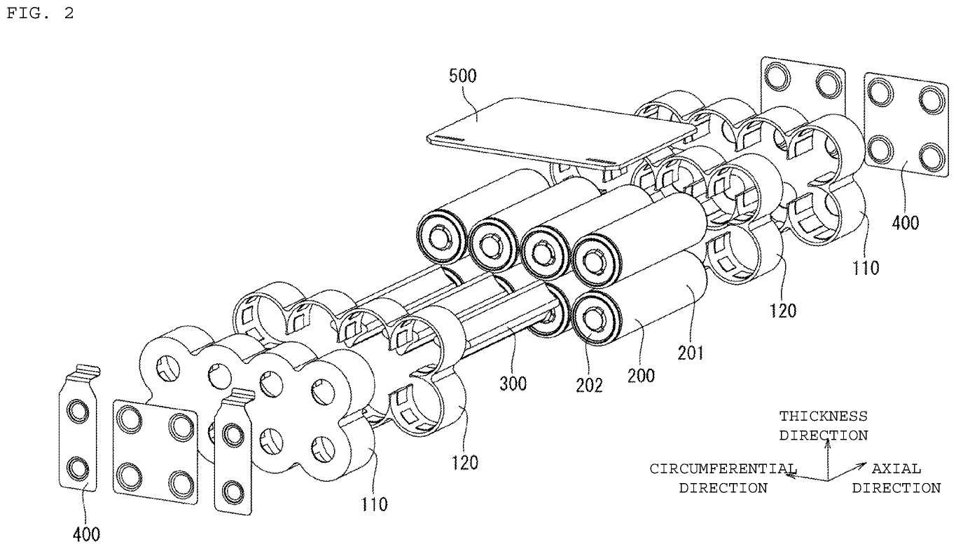

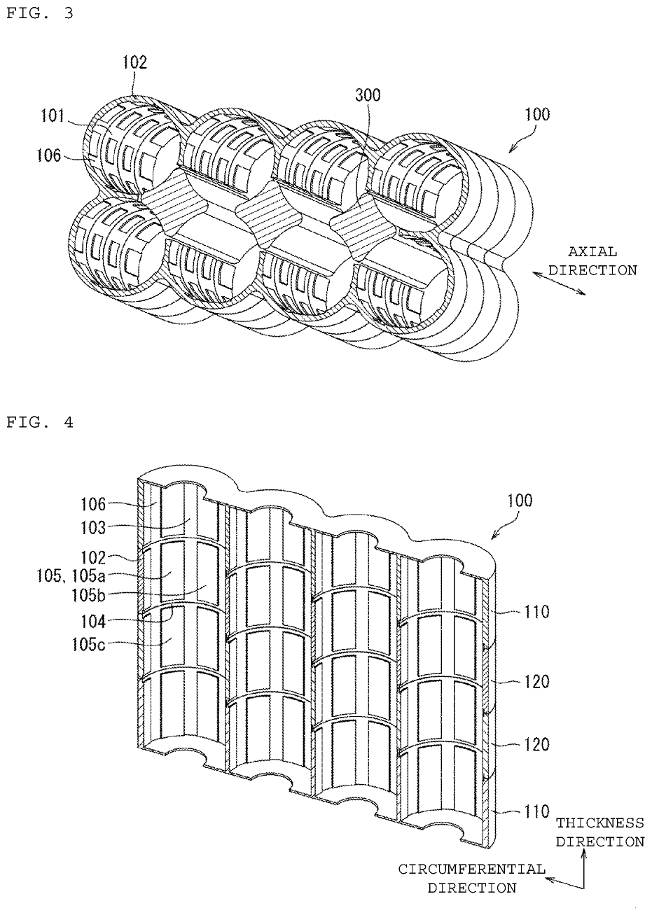

Hereinafter, an overall configuration of a battery pack of a first embodiment of the present disclosure will be described. FIG. 1 is an exploded perspective view schematically showing the battery pack of the first embodiment of the present disclosure. FIG. 2 is an exploded perspective view schematically showing a core pack in the battery pack of the first embodiment. FIG. 3 is a sectional view schematically showing a positional relationship between a battery holder and a heat absorbing member in the battery pack of the first embodiment.

As shown in FIGS. 1 and 2, a battery pack 1000 of the first embodiment includes a plurality of cylindrical batteries 200, a battery holder 100 capable of housing at least the plurality of cylindrical batteries 200, a tab 400 for electrically connecting the cylindrical batteries 200, a substrate 500 connected to the tab, and an exterior body 600 for housing an integrated product (hereinafter, referred to as a battery core pack) of these.

The exterior body 600 may include a main body portion and a lid portion that can be combined with the main body portion. The exterior body 600 is provided with an external terminal 610 connected to the substrate 500. The plurality of cylindrical batteries 200 described later are connected to the external terminal 610 with the substrate 500 interposed therebetween. In addition to the plurality of cylindrical batteries 200, the battery holder 100 can further house a heat absorbing member 300 disposed between one of the cylindrical batteries 200 and the other cylindrical battery 200.

As shown in FIG. 2, the cylindrical battery 200 is housed in a housing portion, which will be described later, of the battery holder 100 described above. In the cylindrical battery 200, an electrode is accommodated in a cylindrical exterior can 201 having a bottom, and an opening of the exterior can 201 is closed by a sealing plate 202 by filling an electrolytic solution. In the cylindrical battery 200, a bottom surface of the exterior can 201 as both end surfaces, and the electrodes provided on the sealing plate 202 are used as positive and negative electrode terminals. For example, the cylindrical battery 200 can be a lithium ion secondary battery that can be charged and discharged.

For the cylindrical battery 200 denoted by reference numeral 200 as described above with reference to FIG. 2, for confirmation, the cylindrical battery refers to that denoted by reference numeral 200 (see FIG. 2) also when reference numerals are not particularly assigned hereinafter.

As shown in FIGS. 2 and 3, the battery holder 100 includes: a plurality of housing portions 101 capable of housing each of the plurality of cylindrical batteries 200 such that the plurality of cylindrical batteries 200 can be arranged adjacent to each other in parallel; and an enclosure 102 that defines at least a part of each of the housing portions 101 (particularly, see FIG. 3). In the present specification, the enclosure 102 can also be referred to as a housing portion, a main body portion, a body portion, or a wall portion.

In the enclosure 102 of the housing portion 101, a predetermined portion of the enclosure 102 located between the adjacent cylindrical batteries 200 functions as a partition wall between the cylindrical batteries 200. The housing portion 101 is a space in which the cylindrical battery 200 can be housed. As an example, the heat absorbing member 300 disposed in the battery holder 100 can define the remaining or other portion of the housing portion 101 other than the enclosure 102 when the enclosure defines a part of the housing portion 101. That is, the heat absorbing member 300 and the enclosure 102 of the battery holder 100 form a contour that defines the housing portion 101 that houses each of the cylindrical batteries 200. In this case, most of the contour forming the housing portion 101 may be in a continuous form.

The shape of the enclosure 102 of the battery holder 100 and the shape of an outer surface of the heat absorbing member 300 depend on a sectional shape of the cylindrical battery 200 to be housed or inserted. For example, as shown in FIG. 2, when the sectional shape of cylindrical battery 200 is a perfect circular shape, the shape of enclosure 102 of the battery holder 100 and the shape of the outer surface of the heat absorbing member 300 may also have a curved shape corresponding to the perfect circular shape. When the sectional shape of cylindrical battery 200 is an elliptical shape, the shape of enclosure 102 of the battery holder 100 and the shape of the outer surface of the heat absorbing member 300 may also have a curved shape corresponding to the elliptical shape.

In this case, a central axis in the axial direction of the cylindrical battery 200 in FIG. 2 preferably coincides with a central axis of the space of the housing portion 101. In this case, when the cylindrical battery 200 is housed in the housing portion 101, a distance between the central axis of adjacent one of the cylindrical batteries 200 and the central axis of adjacent the other cylindrical battery 200 is less likely to change, so that tabbing by the tab 400 that electrically connects the cylindrical batteries 200 described later can be easily performed.

As described above, the cylindrical battery 200, the heat absorbing member 300, and the enclosure 102 of the battery holder 100 can be arranged such that an outer periphery of the cylindrical battery 200 in a circumferential direction can face the enclosure 102 of the battery holder 100 and the heat absorbing member 300 provided adjacent to the enclosure 102 in the same circumferential direction in a state where the cylindrical battery 200 is disposed in the housing portion 101 of the battery holder 100.

The battery holder 100 is molded in a predetermined shape by a resin such as a thermoplastic resin which is an insulating material. As such a resin, for example, polycarbonate (PC) or polypropylene (PP) can be used.

The tab 400 is housed in the housing portion 101 and electrically connects the adjacent cylindrical batteries 200 to each other. The cylindrical batteries 200 may be electrically connected in series or electrically connected in parallel by the tab 400. In order to perform such an electrical connection, the tab 400 is preferably formed from a material having good electrical conductivity. As an example, metal is preferable.

The exterior body 600 only needs to be able to stably house the battery core pack described above. It is preferable to use an insulating material in consideration of safety of the battery pack. In addition, the exterior body 600 may be provided with a connector and the like for extracting electric power generated by the cylindrical battery 200 housed inside.

After the above overall configuration is described, a characteristic portion of the first embodiment of the present disclosure will be described below. The first embodiment of the present disclosure is characterized in the configuration of the battery holder 100.

Specifically, in the battery holder 100, a first groove 103 and a second groove 104 are provided on an inner surface 106 of the enclosure 102 along the outer periphery of the plurality of cylindrical batteries 200, and the first groove 103 and the second groove 104 are connected. In the present specification, the “inner surface of the enclosure of the battery holder” can also be referred to as an inner main surface or an inner side surface. In the present embodiment, a width of the first groove 103 and a width of the second groove 104 may be substantially the same, or the width of the second groove 104 may be twice or less the width of the first groove 103. The width of the second groove 104 may be narrower than the width of the first groove 103.

The “inner surface of the battery holder” referred to herein refers to a side surface located inside the enclosure 102 of the battery holder. As used herein, the “first groove 103” is a groove extending along the axial direction (see FIG. 1) of the cylindrical battery 200 housed in the battery holder 100, and the “second groove 104” is a groove extending along the circumferential direction (see FIG. 1) of the cylindrical battery 200 housed in the battery holder 100.

The first groove 103 and the second groove 104 can be formed by a plurality of protrusions 105 provided on the inner surface 106 of the enclosure 102 of the battery holder 100.

Specifically, as shown in FIG. 4, the plurality of protrusions 105 are provided along the circumferential direction of the cylindrical battery 200 housed in the battery holder 100, and along the axial direction of the cylindrical battery 200 housed in the battery holder 100. That is, the plurality of protrusions 105 are provided along both the circumferential direction and the axial direction.

As an example, as shown in FIG. 4, protrusions 105a and 105c adjacent to each other at predetermined intervals are arranged in the axial direction of the cylindrical battery 200, and the second groove 104 is formed between the protrusions. The protrusions 105a and 105b adjacent to each other at predetermined intervals are arranged in the circumferential direction of the cylindrical battery 200, and the first groove 103 is formed between the protrusions. Since the first groove 103 and the second groove 104 are formed between the two protrusions adjacent to each other at predetermined intervals, the first groove 103 and the second groove 104 can also be referred to as a first recess and a second recess, respectively.

In a configuration in which the plurality of protrusions 105, the first groove 103, and the second groove 104 are provided on the inner surface 106 of the enclosure 102 of the battery holder 100, from another viewpoint, the battery pack of the present disclosure has a feature in which the protrusion 105 has a portion surrounded by the first groove 103 and the second groove 104.

In the present disclosure, the heat absorbing member 300 described above includes a heat absorbing agent and an exterior material enclosing the heat absorbing agent. As an example, the heat absorbing agent can be enclosed by fusing two exterior materials facing each other. With the structure of the exterior material, as described later, the internal heat absorbing agent can be prevented from leaking out except when the cylindrical battery 200 at a predetermined portion abnormally generates heat. That is, due to the structure of the exterior material of the heat absorbing member 300, the internal heat absorbing agent can be stably held, and high safety can be secured for a long period of time.

The heat absorbing agent contains a liquid such as water as a main component, and a gelling agent for easy handling, a surfactant for improving hydrophilicity, and the like may be added. As the gelling agent, polyvinyl alcohol and the like can be used. The content of the liquid such as water in the heat absorbing agent may be, for example, 50% by weight to 99% by weight. Although not particularly limited, the exterior material may include a metal layer and different types of resin layers arranged on both main surfaces of the metal layer. The metal material is formed of, for example, an Al layer. The first resin layer may include polyethylene terephthalate (PET), and the second resin layer may include polyethylene. The thicknesses of the metal material layer and each of the resin layers may be about several tens μm.

Hereinafter, operations and effects of the heat absorbing member 300 when the cylindrical battery 200 at a predetermined portion abnormally generates heat will be described. When the cylindrical battery 200 at a predetermined portion abnormally generates heat, the heat absorbing agent inside the heat absorbing member close to an abnormally heat-generated portion of the battery expands, and an internal pressure increases. As a result, the heat absorbing member 300 is cleaved, and the heat absorbing agent can be released to the outside from a cleavage site as a starting point.

Specifically, as described above, the heat absorbing member 300 and the enclosure 102 of the battery holder 100 form the contour that defines the housing portion 101 that houses the cylindrical battery 200. In this case, the heat absorbing member 300 and the inner surface 106 of the enclosure 102 are arranged adjacent to each other. In addition, the first groove 103 and the second groove 104 provided on the inner surface 106 of the enclosure 102 and connected to each other have different extending directions, and thus can take an intersecting form. From another point of view, the first groove 103 and the second groove 104 have different extending directions, and thus form a groove in a bent form as a whole.

By adopting the configuration as described above, both the first groove 103 and the second groove 104 can act as grooves through which the heat absorbing agent included in the heat absorbing member provided in the battery holder 100 can pass. This makes it possible to spread the heat absorbing agent over the outer periphery of the cylindrical battery 200 along the axial direction and the circumferential direction of the cylindrical battery 200. As a result, the cylindrical battery 200 can be cooled not only locally in the abnormally heat-generated portion but also over a wide range.

As shown in FIGS. 2 and 3, in the aspect in which the heat absorbing member 300 is disposed between one of the cylindrical batteries 200 and the other cylindrical battery 200, heat transfer from the cleavage site of the heat absorbing member 300 as a starting point to the plurality of cylindrical batteries 200 (including the cylindrical batteries 200 that have abnormally generated heat and the other adjacent cylindrical batteries 200 that have not abnormally generated heat) adjacent to the position where the heat absorbing member 300 is disposed can be reduced. As a result, chain heating and the like to other cylindrical batteries 200 located in the battery holder 100 and not abnormally generating heat can be prevented, and a failure of the battery pack 1000 can be minimized. That is, heat transfer between the plurality of cylindrical batteries 200 can be suitably suppressed.

It is also possible to cool high-temperature gas that can be jetted from the cylindrical battery 200 that has abnormally generated heat to a flash point or lower by the heat absorbing agent. Thus, the jetted gas can be discharged to the outside of the battery pack 1000 at a temperature equal to or lower than the flash point through the external terminal 610 of the exterior body 600, for example. That is, it is possible to discharge the jetted gas to the outside of the battery pack 1000 in a state where the occurrence of flame caused by ignition is prevented.

From the above, also in the aspect in which the heat absorbing member 300 is locally disposed between one of the cylindrical batteries 200 and the other cylindrical battery 200, the battery pack of the first embodiment is superior to the conventional battery pack in that suitable cooling of the cylindrical battery 200 over a wide range and chain heating to the other cylindrical batteries 200 that do not generate abnormal heat can be prevented through the above two kinds of grooves.

It is preferable that a plurality of the first grooves 103 and a plurality of the second grooves 104 are provided. When the number of the first grooves extending in the axial direction of the cylindrical battery 200 and the number of the second grooves extending in the circumferential direction of the cylindrical battery 200 are plural, a route for spreading the heat absorbing agent to the outer periphery of the cylindrical battery 200 can be increased along the axial direction and the circumferential direction of the cylindrical battery 200. As a result, the cylindrical battery 200 can be suitably cooled over a wider range.

Hereinafter, a characteristic configuration of the battery holder 100 according to the first embodiment will be described.

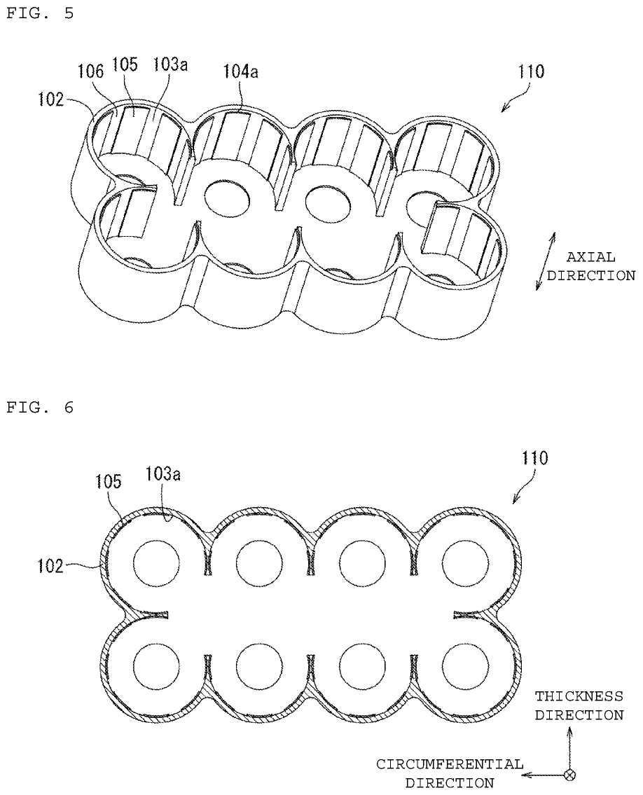

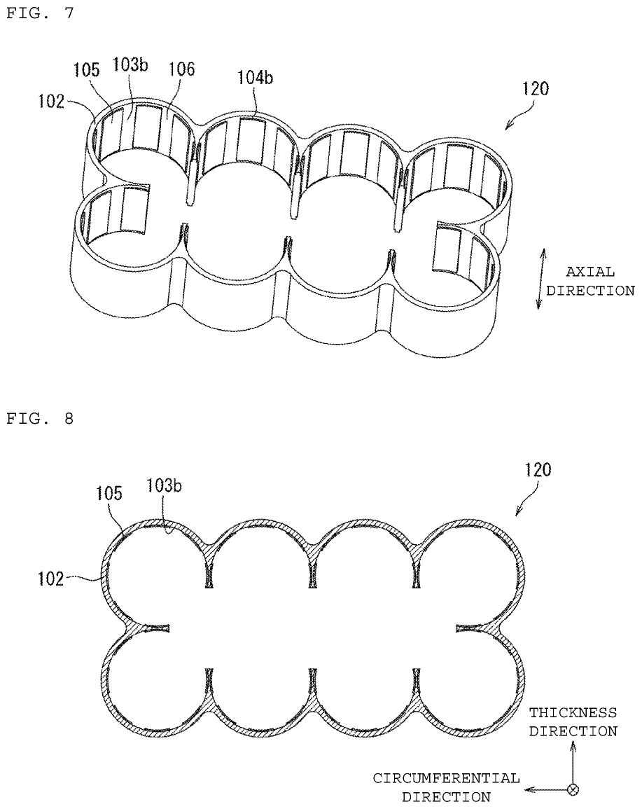

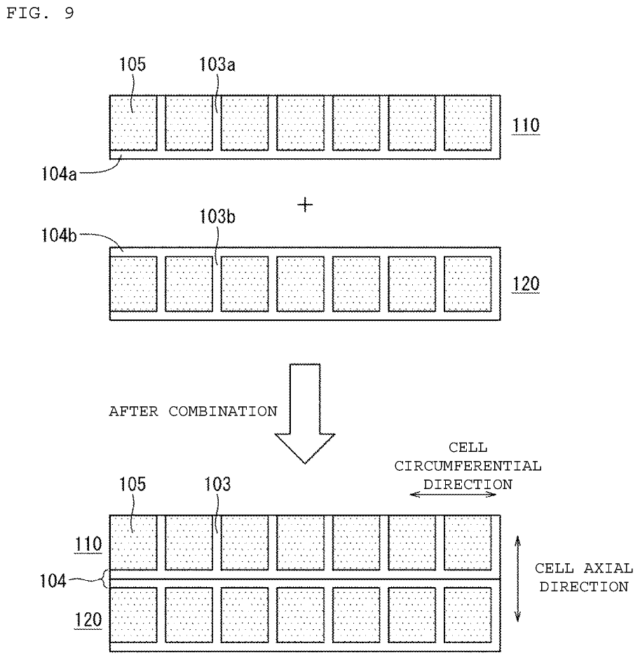

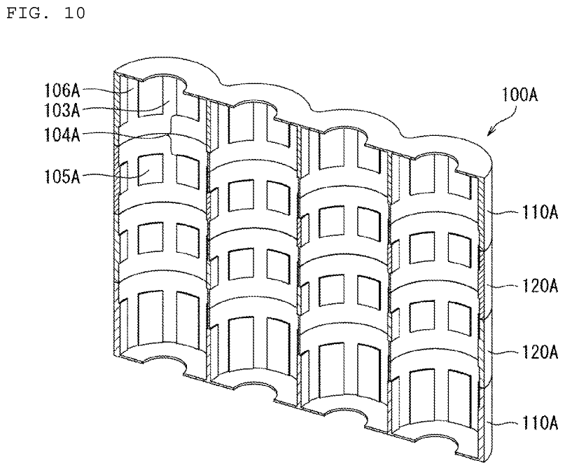

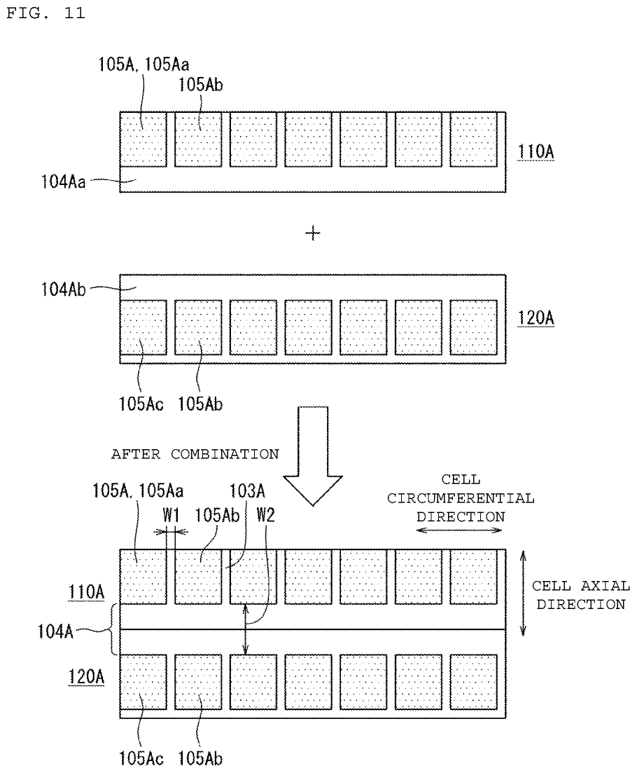

FIG. 4 is a sectional view schematically showing the battery holder between line segments A-A in FIG. 1. FIG. 5 is a sectional view schematically showing a first battery holder component in the battery pack of the first embodiment. FIG. 6 is a front view schematically showing the first battery holder component viewed from an angle different from that in FIG. 5. FIG. 7 is a sectional view schematically showing a second battery holder component in the battery pack of the first embodiment. FIG. 8 is a front view schematically showing the second battery holder component viewed from an angle different from that in FIG. 7. FIG. 9 is a schematic view of a formation mode of the first groove and the second groove of the battery holder using a plurality of battery holder components in the battery pack of the first embodiment.

As shown in FIGS. 2 and 4, and other figures, the battery holder 100 according to the first embodiment includes battery holder components 110 and 120 that are divided into a plurality of battery holder components in the axial direction of the cylindrical battery 200 housed in the battery holder 100. In other words, the battery holder 100 includes a plurality of the battery holder components 110 and 120 connected to each other along the axial direction. In the example shown in FIG. 4, the first battery holder component 110, the second battery holder component 120, the second battery holder component 120, and the first battery holder component 110 are connected to each other in this order along the axial direction. Each battery holder component has a row of protrusions 105 at predetermined intervals along the circumferential direction.

The “first battery holder component 110” as used herein refers to a component (holder component) of the battery holder 100 capable of receiving both ends in the axial direction of the cylindrical battery, the component including a receiving portion in which one side is fully opened in the axial direction and the other side is capable of receiving the cylindrical battery, and a partial opening for the cylindrical battery inside to come into contact with the tab (see FIGS. 5 and 6). The first battery holder component 110 includes a sub groove 103a forming a part of the first groove 103 and a sub groove 104a forming a part of the second groove 104.

The “second battery holder component 120” as used herein is a component (holder component) of the battery holder 100 in the form of a through hole capable of receiving a middle portion of the cylindrical battery in the axial direction (see FIGS. 7 and 8). The second battery holder component 120 includes a sub groove 103b forming a part of the first groove 103 and a sub groove 104b forming a part of the second groove 104. Under such a configuration, a width of the sub groove forming a part of the second groove 104 and a width of the sub groove forming a part of the first groove 103 may be the same or substantially the same.

The plurality of battery holder components 110 and 120 are arranged in series. In such a configuration, the second groove 104 may include one battery holder component and the other battery holder component connected to each other along the axial direction. In an example, the second groove 104 may be formed at an interconnection location of the first battery holder component 110 and the second battery holder component 120 (see FIG. 9). In another example, the second groove 104 may be formed at the second battery holder component 120 and an interconnection location between the second battery holder components 120.

Hereinafter, second to sixth embodiments will be described. From the viewpoint of avoiding duplication of description, each embodiment will be described focusing on differences from the first embodiment.

Hereinafter, a characteristic configuration of a battery pack of a second embodiment of the present disclosure will be described.

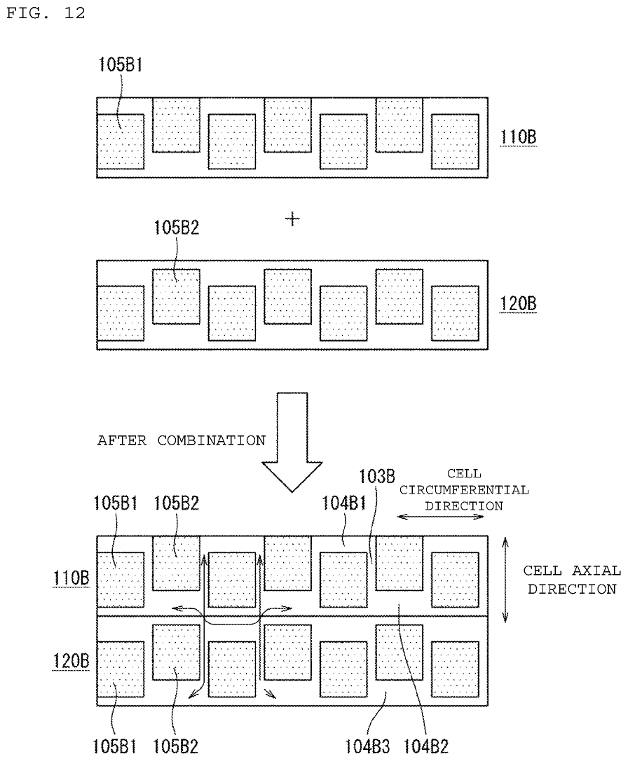

FIG. 10 is a sectional view schematically showing a battery holder between line segments A-A in FIG. 1 in the battery pack of the second embodiment of the present disclosure. FIG. 11 is a schematic view of a formation mode of a first groove and a second groove of the battery holder using a plurality of battery holder components in the battery pack of the second embodiment.

The second embodiment is different from the first embodiment in that a width W2 of the second groove of an inner surface 106A of an enclosure of a battery holder 100A is larger than a width W1 of the first groove from the viewpoint of the groove (see FIGS. 10 and 11). As an example, a width of a second groove 104A may be greater than twice a width of the first groove 103A, for example, may be three to four times the width.

From the viewpoint of the protrusion, a distance W2 between a plurality of protrusions 105Aa and 105Ac provided along the axial direction of the cylindrical battery housed in the battery holder 100A is wider than a distance W1 between a plurality of protrusions 105Aa and 105Ab provided along the circumferential direction of the cylindrical battery housed in the battery holder 100A.

In the second embodiment, a first battery holder component 110A which is a component of the battery holder 100A includes a sub groove forming a part of the first groove and a sub groove 104Aa forming a part of the second groove 104A. The second battery holder component 120A includes a sub groove forming a part of the first groove and a sub groove 104Ab forming a part of the second groove 104A. The sub groove forming a part of the second groove 104A is larger in width than the sub groove forming a part of the first groove.

In such a configuration, the second groove 104A may include one battery holder component and the other battery holder component connected to each other along the axial direction. In an example, the second groove 104A may be formed at an interconnection location of the first battery holder component 110A and the second battery holder component 120A (see FIG. 11). In another example, the second groove 104A may be formed at the second battery holder component 120A and an interconnection location between the second battery holder components 120A (see FIG. 10).

According to the above feature, the width W2 of the second groove 104A of the inner surface 106A of the battery holder 100A is larger than the width W1 of the first groove 103A, or the distance W2 between the plurality of protrusions 105Aa and 105Ac is larger than the distance W1 between the plurality of protrusions 105Aa and 105Ab. Thus, in particular, the heat absorbing agent can be more suitably spread over the outer periphery of the cylindrical battery along the circumferential direction of the cylindrical battery. That is, the heat absorbing agent can be easily spread in the circumferential direction. This makes it possible to more suitably suppress heat propagation to the adjacent cylindrical batteries as compared with the first embodiment.

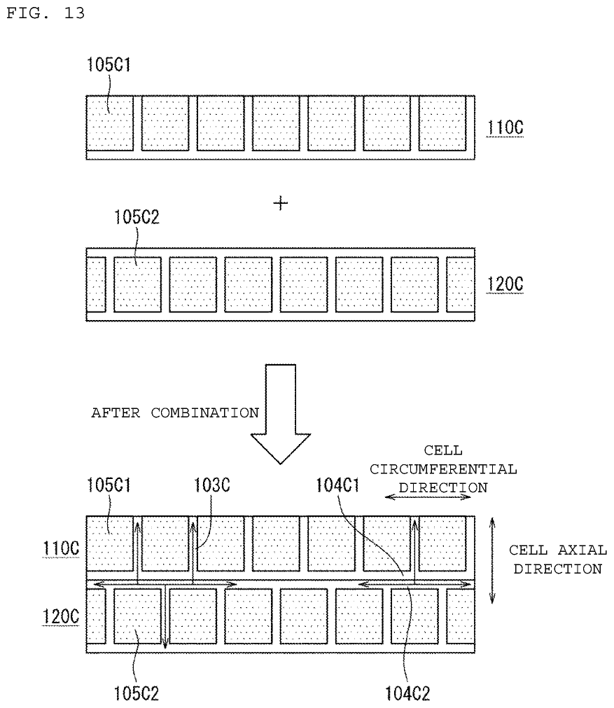

Hereinafter, a characteristic configuration of a battery pack of a third embodiment of the present disclosure will be described. FIG. 12 is a schematic view of a formation mode of a first groove and a second groove of the battery holder using a plurality of battery holder components in the battery pack of the third embodiment.

The third embodiment is different from the first embodiment in that the second groove on an inner surface of the battery holder is connected to a plurality of mutually different portions of the first groove from the viewpoint of the groove (see FIG. 12).

As an example, as shown in FIG. 12, when attention is paid to one first groove 103B extending along the axial direction, one second groove 104B1 is connected to one end of the one first groove 103B, and the other second groove 104B3 is connected to the other end of the one first groove. Another second groove 104B2 is further connected to a predetermined region (near the center region) of the one first groove 103B.

From the viewpoint of the protrusion, a plurality of protrusions 105B1 and 105B2 provided along the circumferential direction of a cylindrical battery housed in the battery holder are provided at positions where the plurality of protrusions is arranged alternately as viewed from the circumferential direction of the cylindrical battery (see FIG. 12).

In such a configuration, there is a positional relationship in which a portion extending in the longitudinal direction of the second grooves 104B1 to 104B3 and the protrusion 105B1 or 105B2 face each other. Due to this facing positional relationship, first, the heat absorbing agent jetted from the inside of the heat absorbing member can come into contact with the surfaces, particularly the side surfaces, of the protrusions 105B1 and 105B2.

At such a contact portion, due to the presence of the protrusions 105B1 and 105B2, the heat absorbing member cannot continuously move along the longitudinal direction of the second grooves 104B1 to 104B3, and a part thereof can move along the first groove 103B intersecting the second grooves 104B1 to 104B3.

In this regard, in the first embodiment, since the portion extending in the longitudinal direction of the groove and the protrusion are not in the positional relationship of directly facing each other, the heat absorbing agent is continuously movable along the longitudinal direction of the groove. On the other hand, in the third embodiment, as compared with the first embodiment, the heat absorbing agent that moves along the longitudinal direction of the second grooves 104B1 to 104B3 is divided into a heat absorbing agent that moves along the second groove and a heat absorbing agent that moves along the first groove with the contact portion as a starting point. That is, as compared with the first embodiment, a movement path of the heat absorbing agent can be branched with the contact portion as a starting point, and as a result, the number of movement paths of the heat absorbing agent can be increased.

As described above, as compared with the first embodiment, the heat absorbing agent can be radially diffused through the second grooves 104B1 to 104B3 and the first groove 103B from the contact portion as a starting point. As a result, it is possible to efficiently and effectively cool the abnormally heat-generated portion of the cylindrical battery and the vicinity thereof.

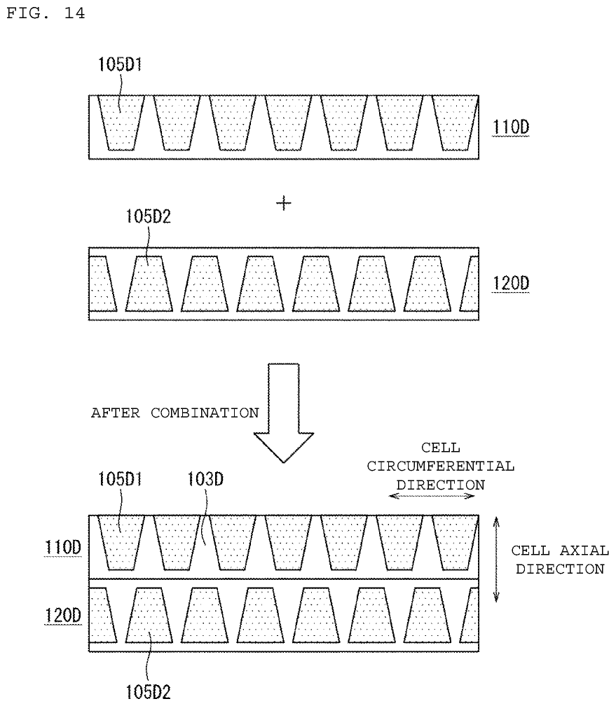

Hereinafter, a characteristic configuration of a battery pack of a fourth embodiment of the present disclosure will be described. FIG. 13 is a schematic view of a formation mode of a first groove and a second groove of a battery holder using a plurality of battery holder components in the battery pack of the fourth embodiment.

The fourth embodiment is different from the first embodiment in that a plurality of second grooves 104C1 and 104C2 on the inner surface of the battery holder are connected to predetermined portions of a first groove 103C from the viewpoint of the groove (see FIG. 13). Specifically, as shown in FIG. 13, one second groove 104C1 and the other second groove 104C2 are connected to one end of the first groove 103C.

From the viewpoint of the protrusion, a plurality of protrusions 105C1 and 105C2 provided along the axial direction of a cylindrical battery housed in the battery holder are provided at positions where the plurality of protrusions 105C1 and 105C2 alternate as viewed from the axial direction of the cylindrical battery (see FIG. 13).

In such a configuration, there is a positional relationship in which a portion extending in the longitudinal direction of the first groove 103C and the protrusions 105C1 and 105C2 face each other. Due to this facing positional relationship, first, the heat absorbing agent jetted from the inside of the heat absorbing member can come into contact with the surfaces, particularly the side surfaces, of the protrusions 105C1 and 105C2.

At such a contact portion, due to the presence of the protrusions 105C1 and 105C2, the heat absorbing member cannot continuously move along the longitudinal direction of the first groove 103C, and a part thereof intersects the first groove 103C and can move along the second grooves 104C1 and 104C2 connected and integrated with each other.

In this regard, in the first embodiment, since the portion extending in the longitudinal direction of the first groove and the protrusion are not in the positional relationship of directly facing each other, the heat absorbing agent is continuously movable along the longitudinal direction of the first groove. On the other hand, in the fourth embodiment, as compared with the first embodiment, the heat absorbing agent that moves along the longitudinal direction of the first groove 103C is divided into a heat absorbing agent that moves along the first groove and a heat absorbing agent that moves along the second groove with the contact portion as a starting point. That is, as compared with the first embodiment, a movement path of the heat absorbing agent can be branched with the contact portion as a starting point, and as a result, the number of movement paths of the heat absorbing agent can be increased.

As described above, as compared with the first embodiment, the heat absorbing agent can be radially diffused through the first groove 103C and the second grooves 104C1 and 104C2 from the contact portion as a starting point. As a result, it is possible to efficiently and effectively cool the abnormally heat-generated portion of the cylindrical battery and the vicinity thereof.

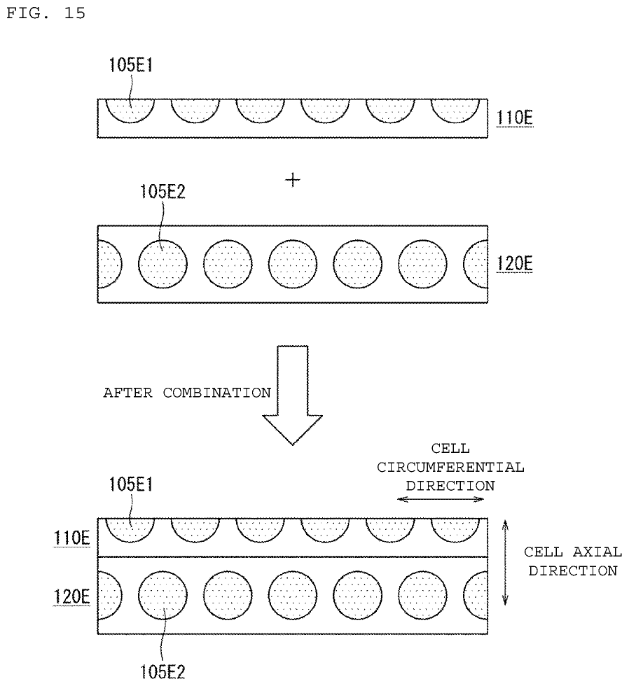

Hereinafter, a characteristic configuration of a battery pack of a fifth embodiment of the present disclosure will be described. FIG. 14 is a schematic view of a formation mode of a first groove and a second groove of a battery holder using a plurality of battery holder components in the battery pack of the fifth embodiment.

The fifth embodiment is a modification of the fourth embodiment. Specifically, in the fifth embodiment, similarly to the fourth embodiment, the plurality of protrusions 105D1 and 105D2 provided along the axial direction of the cylindrical battery housed in the battery holder are provided at positions where the plurality of protrusions 105D1 and 105D2 alternate as viewed from the axial direction of the cylindrical battery (see FIG. 14).

On the other hand, as viewed in the thickness direction of the cylindrical battery (see also FIG. 2), the shape of the protrusion is tapered from a first battery holder component 110D to a second battery holder component 120D. That is, a first groove 103D has a reverse tapered shape.

As a result, the width of the first groove is gradually different. Thus, it is possible to increase a flow rate when the heat absorbing agent is radially diffused through the path of the groove with the cleavage site of the heat absorbing member as a starting point. As a result, it is possible to cause the heat absorbing agent to spread farther over a wide range of the outer periphery of the cylindrical battery from the cleavage site as a starting point.

Hereinafter, a characteristic configuration of a battery pack of a sixth embodiment of the present disclosure will be described. FIG. 15 is a schematic view of a formation mode of a first groove and a second groove of a battery holder using a plurality of battery holder components in the battery pack of the sixth embodiment.

The sixth embodiment is a modification of the fourth embodiment. Specifically, in the sixth embodiment, similarly to the fourth embodiment, a plurality of protrusions 105E1 and 105E2 provided along the axial direction of the cylindrical battery housed in the battery holder are provided at positions where the plurality of protrusions 105E1 and 105E2 alternate as viewed from the axial direction of the cylindrical battery (see FIG. 15).

On the other hand, the shape of the protrusion is a circular shape or a semicircular shape as viewed in the thickness direction of the cylindrical battery (see also FIG. 2). That is, the protrusions 105E1 and 105E2 do not have a bent portion and have a curved shape (corresponding to an R shape).

Due to the shape of the protrusion, the heat absorbing agent jetted from the inside of the heat absorbing member can reduce pressure loss that can occur when the heat absorbing agent can come into contact with the surface, particularly the side surface, of the protrusion. Thus, it is possible to increase a flow rate when the heat absorbing agent is radially diffused through the path of the groove with the cleavage site of the heat absorbing member as a starting point. As a result, it is possible to cause the heat absorbing agent to spread farther over a wide range of the outer periphery of the cylindrical battery from the cleavage site as a starting point.

It is to be noted that embodiments disclosed herein are considered by way of illustration in all respects, and not considered as a basis for restrictive interpretations. Accordingly, the technical scope of the present disclosure is not to be construed only by the embodiments mentioned above, but is defined based on the description of the claims. In addition, the technical scope of the present disclosure encompasses meanings equivalent to the claims and all modifications within the scope of the claims.

The battery pack of the present disclosure includes the following aspects according to an embodiment.

<1>

A battery pack including:
a plurality of cylindrical batteries;
a heat absorbing member disposed between one cylindrical battery and another cylindrical battery of the plurality of cylindrical batteries; and
a battery holder that houses the plurality of cylindrical batteries and the heat absorbing member,
wherein
the battery holder includes an enclosure along an outer periphery of the plurality of cylindrical batteries,
a first groove extending along an axial direction of the cylindrical battery housed in the battery holder and a second groove extending along a circumferential direction of the cylindrical battery housed in the battery holder are provided on an inner surface of the enclosure of the battery holder, and
the first groove and the second groove are connected to each other.
   <2>

The battery pack according to <1>, wherein a plurality of the first grooves are provided, and a plurality of the second grooves are provided.

<3>

The battery pack according to <1> or <2>, wherein a width of the second groove is larger than a width of the first groove.

<4>

The battery pack according to any one of <1> to <3>, wherein the second groove is connected to a plurality of mutually different portions of the first groove.

<5>

The battery pack according to <4>, wherein one second groove is connected to one end of the first groove, and another second groove is connected to the other end of the first groove.

<6>

The battery pack according to any one of <1> to <5>, wherein the plurality of second grooves are connected to a predetermined portion of the first groove.

<7>

The battery pack according to <6>, wherein one second groove and another second groove are connected to one end of the first groove.

<8>

A battery pack including:
a plurality of cylindrical batteries;
a heat absorbing member disposed between one cylindrical battery and another cylindrical battery of the plurality of cylindrical batteries; and
a battery holder that houses the plurality of cylindrical batteries and the heat absorbing member,
wherein
the battery holder includes an enclosure along an outer periphery of the plurality of cylindrical batteries, a plurality of protrusions are provided on an inner surface of the enclosure, and
the plurality of protrusions are provided along a circumferential direction of the cylindrical battery housed in the battery holder, and are provided along an axial direction of the cylindrical battery housed in the battery holder.
   <9>

The battery pack according to <8>, wherein a distance between a plurality of protrusions provided along the axial direction of the cylindrical battery housed in the battery holder is wider than a distance between a plurality of protrusions provided along the circumferential direction of the cylindrical battery housed in the battery holder.

<10>

The battery pack according to <8> or <9>, wherein a plurality of protrusions provided along the circumferential direction of the cylindrical battery housed in the battery holder are provided at positions where the plurality of protrusions is arranged alternately as viewed from the circumferential direction of the cylindrical battery.

<11>

The battery pack according to any one of <8> to <10>, wherein a plurality of protrusions provided along the axial direction of the cylindrical battery housed in the battery holder are provided at positions where the plurality of protrusions is arranged alternately as viewed from the axial direction of the cylindrical battery.

<12>

The battery pack according to any one of <1> to <11>, wherein the battery holder includes a battery holder component that are divided into a plurality of battery holder components in the axial direction of the cylindrical battery housed in the battery holder.

<13>

The battery pack according to <12>, wherein the second groove includes one battery holder component and another battery holder component of the plurality of battery holder components connected to each other along the axial direction.

<14>

The battery pack according to <12> or <13>, wherein the plurality of battery holder components are arranged in series.

<15>

The battery pack according to any one of <1> to <7> and <12> to <14>, wherein a groove in a bent form includes the first groove and the second groove.

<16>

The battery pack according to any one of <1> to <7> and <12> to <15>, wherein the first groove and the second groove intersect each other.

<17>

A battery pack including:
a plurality of cylindrical batteries;
a heat absorbing member disposed between one cylindrical battery and another cylindrical battery of the plurality of cylindrical batteries; and
a battery holder that houses the plurality of cylindrical batteries and the heat absorbing member,
wherein
the battery holder includes an enclosure along an outer periphery of the plurality of cylindrical batteries,
a plurality of protrusions are provided on an inner surface of the enclosure of the battery holder, a first groove extending along an axial direction of the cylindrical battery housed in the battery holder and a second groove extending along a circumferential direction of the cylindrical battery housed in the battery holder are provided on the inner surface of the enclosure of the battery holder, and
the protrusion includes a portion surrounded by the first groove and the second groove.
   <18>

The battery pack according to <17>, wherein a portion extending in a longitudinal direction of the first groove or the second groove faces the protrusion.

In an embodiment, the battery pack of the present disclosure can be used as a power supply for power. The battery pack is used, for example, as a power supply of an electric device driven by a motor such as an electric tool or an electric power-assisted bicycle.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A battery pack comprising:
a plurality of cylindrical batteries;
a heat absorbing member disposed between one cylindrical battery and another cylindrical battery of the plurality of cylindrical batteries; and
a battery holder that houses the plurality of cylindrical batteries and the heat absorbing member,
wherein
the battery holder includes an enclosure along an outer periphery of the plurality of cylindrical batteries,
a first groove extending along an axial direction of the cylindrical battery housed in the battery holder and a second groove extending along a circumferential direction of the cylindrical battery housed in the battery holder are provided on an inner surface of the enclosure of the battery holder, and the first groove and
the second groove are connected to each other.

2. The battery pack according to claim 1, wherein a plurality of the first grooves are provided, and a plurality of the second grooves are provided.

3. The battery pack according to claim 1, wherein a width of the second groove is larger than a width of the first groove.

4. The battery pack according to claim 1, wherein the second groove is connected to a plurality of mutually different portions of the first groove.

5. The battery pack according to claim 4, wherein one second groove is connected to one end of the first groove, and another second groove is connected to the other end of the first groove.

6. The battery pack according to claim 1, wherein the plurality of second grooves are connected to a predetermined portion of the first groove.

7. The battery pack according to claim 6, wherein one second groove and another second groove are connected to one end of the first groove.

8. A battery pack comprising:
a plurality of cylindrical batteries;
a heat absorbing member disposed between one cylindrical battery and another cylindrical battery of the plurality of cylindrical batteries; and
a battery holder that houses the plurality of cylindrical batteries and the heat absorbing member,
wherein
the battery holder includes an enclosure along an outer periphery of the plurality of cylindrical batteries,
a plurality of protrusions are provided on an inner surface of the enclosure, and
the plurality of protrusions are provided along a circumferential direction of the cylindrical battery housed in the battery holder, and are provided along an axial direction of the cylindrical battery housed in the battery holder.

9. The battery pack according to claim 8, wherein a distance between a plurality of protrusions provided along the axial direction of the cylindrical battery housed in the battery holder is wider than a distance between a plurality of protrusions provided along the circumferential direction of the cylindrical battery housed in the battery holder.

10. The battery pack according to claim 8, wherein a plurality of protrusions provided along the circumferential direction of the cylindrical battery housed in the battery holder are provided at positions where the plurality of protrusions is arranged alternately as viewed from the circumferential direction of the cylindrical battery.

11. The battery pack according to claim 8, wherein a plurality of protrusions provided along the axial direction of the cylindrical battery housed in the battery holder are provided at positions where the plurality of protrusions is arranged alternately as viewed from the axial direction of the cylindrical battery.

12. The battery pack according to claim 1, wherein the battery holder includes a battery holder component that are divided into a plurality of battery holder components in the axial direction of the cylindrical battery housed in the battery holder.

13. The battery pack according to claim 12, wherein the second groove includes one battery holder component and another battery holder component of the plurality of battery holder components connected to each other along the axial direction.

14. The battery pack according to claim 12, wherein the plurality of battery holder components are arranged in series.

15. The battery pack according to claim 1, wherein a groove in a bent form includes the first groove and the second groove.

16. The battery pack according to claim 1, wherein the first groove and the second groove intersect each other.

17. A battery pack comprising:
a plurality of cylindrical batteries;
a heat absorbing member disposed between one cylindrical battery and another cylindrical battery of the plurality of cylindrical batteries; and
a battery holder that houses the plurality of cylindrical batteries and the heat absorbing member,
wherein
the battery holder includes an enclosure along an outer periphery of the plurality of cylindrical batteries,
a plurality of protrusions are provided on an inner surface of the enclosure of the battery holder, a first groove extending along an axial direction of the cylindrical battery housed in the battery holder and a second groove extending along a circumferential direction of the cylindrical battery housed in the battery holder are provided on the inner surface of the enclosure of the battery holder, and
the protrusion includes a portion surrounded by the first groove and the second groove.

18. The battery pack according to claim 17, wherein a portion extending in a longitudinal direction of the first groove or the second groove faces the protrusion.
